(19) United States
(12) Patent Application Publication
(10) Pub. No.: US 2025/0085761 A1
(43) Pub. Date: Mar. 13, 2025

(54) SYSTEMS AND METHODS FOR COLLECTING SENSOR DATA FROM POWER LINES FOR ELECTRICAL POWER MONITORING

(71) Applicant: Socomec Inc., Watertown, MA (US)

(72) Inventors: Arne LaVen, Bend, OR (US); Sudha LaVen, Bend, OR (US)

(73) Assignee: Socomec Inc., Watertown, MA (US)

(21) Appl. No.: 18/243,602

(22) Filed: Sep. 7, 2023

(51) Int. Cl. G06F 1/3225; G06F 1/3237

(52) U.S. Cl. CPC G06F 1/3225; G06F 1/3237

(57) ABSTRACT

A power meter for a power delivery system has sampling chips for sampling sensor signals from sensors that measure parameters of power signals carried by power lines. A processor of the power meter is configured to collect and analyze samples of the sensor signals from the sampling chips. In this regard, the processor operates in a direct memory access (DMA) mode that allows it to perform other tasks during collection of the samples. Circuitry external to the processor uses the processor's clock signal to selectively control writing of sensor data from the sampling chips to the processor's memory. The circuitry operates in a manner that is transparent to the processor and the sampling chips, and the circuitry has sufficiently fast response time to prevent timing propagation errors.

### RELATED ART

To satisfy the growing demand for measurement of electrical characteristics (including consumption, power factors, var content, etc.) within buildings (referred to as submetering), efficient and low-cost methods are needed to interface with a growing number of sensors that require timing synchronization and efficient transport of data. Measurements in electrical power systems require synchronization between voltage and current flowing in a plurality of downstream circuits, often called branch circuits. The quantity of the measurements necessitates the use of external sensors relaying measurement data back to a central point for processing.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a conventional power delivery system for transferring electrical power.

FIG. 2 is a block diagram illustrating a conventional power meter, such as is depicted by FIG. 1.

FIG. 3 is a block diagram illustrating an embodiment of a power meter in accordance with the present disclosure.

FIG. 4 is a block diagram illustrating an embodiment of circuitry for a power meter, such as is depicted by FIG. 3.

FIG. 5 is a circuit diagram illustrating an embodiment of a driver, such as is depicted by FIG. 4.

### DETAILED DESCRIPTION

The present disclosure generally pertains to systems and methods for collecting sensor data from power lines carrying power signals. In an embodiment of the present disclosure, a processor of a power meter is configured to collect sensor data from sensors that are connected to power lines carrying electrical power to one or more destinations or branch circuits. The processor is coupled to a plurality of sampling chips, and each of the sampling chips is coupled to at least one sensor for receiving at least one sensor signal to be sampled. The sampling chips operate (e.g., clock data in and out) using a clock signal provided by the processor, and collection control circuitry external to the sampling chips and processor uses the processor's clock signal to control writing of sensor data to processor memory. In this regard, the processor operates in a direct memory access (DMA) mode that allows sensor data to be written into the memory without burdening the processing resources (e.g., central processing unit) of the processor. Thus, the processor may simultaneously perform other tasks while the collection control circuitry is controlling the writing of sensor data into the processor memory.

In addition, the collection control circuitry is designed to have a response time that is sufficiently fast to permit all the sensor data for a given sample to be written into the processor memory within a window for receiving the sample, noting that the presence and operation of the collection control circuitry is transparent to the processor and the sampling chips. Thus, sensor data for a sample written into the processor memory appears, from the processor's perspective, to be a large data block effectively from a single source even though such data is actually from multiple sampling chips. That is, the processor is relieved of many of the burdens of having to control the flow of data from multiple sampling chips, thereby permitting the processor to tend to other tasks while sensor data is being written to its memory. Thus, the processor is able to more efficiently handle a greater number of tasks and/or process other tasks at greater speeds. In addition, the collection control circuitry operates sufficiently fast to control writing of data using the processor's clock signal such that timing propagation delays that could otherwise adversely affect the analysis of the sensor measurements are prevented.

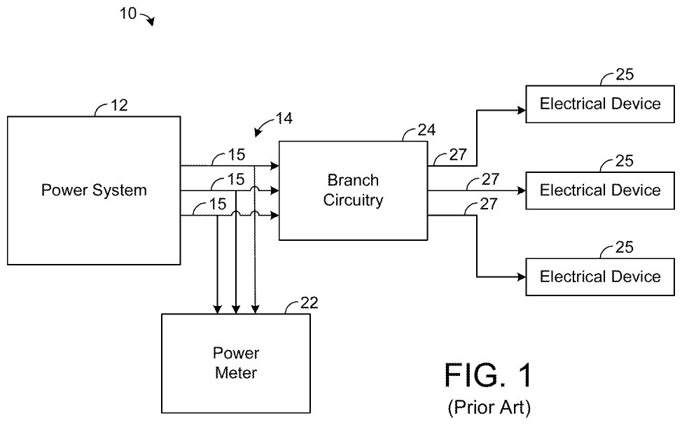

FIG. 1 depicts a conventional power delivery system 10 for transferring electrical power. The system 10 comprises a power system 12 for delivering electrical power via a set 14 of power lines 15 that are connected to a power meter 22. In some embodiments, the system 10 may be a three-phase system that delivers three-phase electrical power across at least three power lines 15. In this regard, a set 14 of three-phase power lines 15 typically includes three power lines 15 where each power line 15 carries an alternating current (AC) power signal, and the power signal of each power line 15 has a phase difference of about 120 degrees relative to the AC signals carried by the other two lines 15 of the set 14. In other embodiments, the use of three-phase power signals is unnecessary, and there may be any number of power lines 15 (e.g., one or more) carrying electrical power to be measured by the power meter 22. As shown by FIG. 1, the power lines 15 may be coupled to branch circuitry 24 that delivers electrical power from the power lines 15 to one or more downstream electrical devices 25 that receive and consume electrical power.

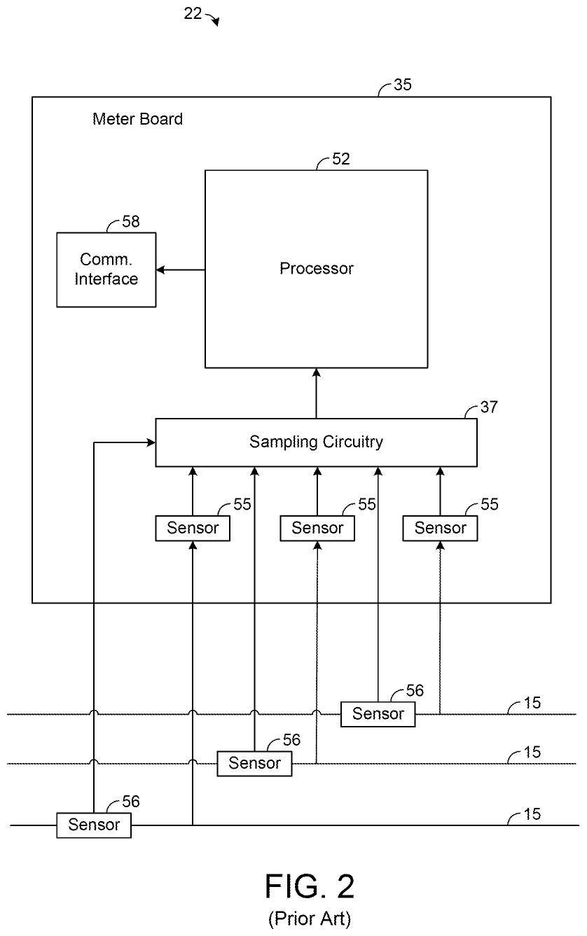

FIG. 2 depicts an embodiment of the power meter 22. In this regard, the power meter 22 has a substrate 35 (e.g., a printed circuit board (PCB)) on which various other components of the power meter 22 shown by FIG. 2 may reside. As shown by FIG. 2, the power meter 22 comprises a processor 52 that is configured to monitor the power signals carried by the power lines 15. In this regard, a plurality of sensors 55, 56 are coupled to the power lines 15 and measure various parameters (e.g., voltage and/or current) of each power signal carried by the lines 15. As an example, the system 10 may have at least one current sensor 56 and at least voltage sensor 55 electrically coupled to each power line 15. In the embodiments shown by FIG. 2, each current sensor 56 is mounted on a respective power line 15, and each voltage sensor 55 is mounted on the board 35. However, other locations of the sensors 55, 56 are possible.

As shown by FIG. 2, sampling circuitry 37 is coupled to the sensors 55, 56 and configured to sample analog sensor signals from the sensors 55, 56 to generate digital sensor data that may be provided to the processor 52. As an example, the sampling circuitry 37 may include various sampling chips (not specifically shown) that operate under the control of the processor 52 in order to send the sensor data to the processor 52 for storage and analysis.

The processor 52 is configured to collect the sensor data and to analyze the sensor data to monitor the power signals carried by the power lines 15. As an example, the processor 52 may receive many samples of the sensor data over time and analyze such samples to calculate an amount of electrical power delivered by the power lines 15 (e.g., total power or current delivered over one or more windows of time) the branch circuitry 24 or other downstream components.

The processor 52 may be connected to a communication interface 58, such as a modem or other type of transceiver, and use such communication interface 58 to communicate information about the monitored power to an external device. As an example, the communication interface 58 may communicate through one or more networks (not shown), such as the Internet, with a server or other device to convey information about the received power. Such information may be used for a variety of purposes, such as monitoring the health of the system 10 or billing a customer based on the amount of electrical power delivered over time.

Note that each sample of sensor data includes an amount of data indicative of measurements by each sensor 55, 56 connected to the power lines 15. Further, the same power meter 22 may be used to monitor many sets of power lines 15, requiring a large number of sensors 55, 56. Thus, the amount of data included in each sample can be relatively large. In addition, for accurate analysis, it is desirable for all the data in each respective sample to be from simultaneous measurements, i.e., be recorded at the same instant in time. Clocking in a large amount of data that should be measured simultaneously from multiple power lines 15 can be challenging or problematic as all the data must be collected before the next sampling interval and is subject to propagation delays in routing circuitry.

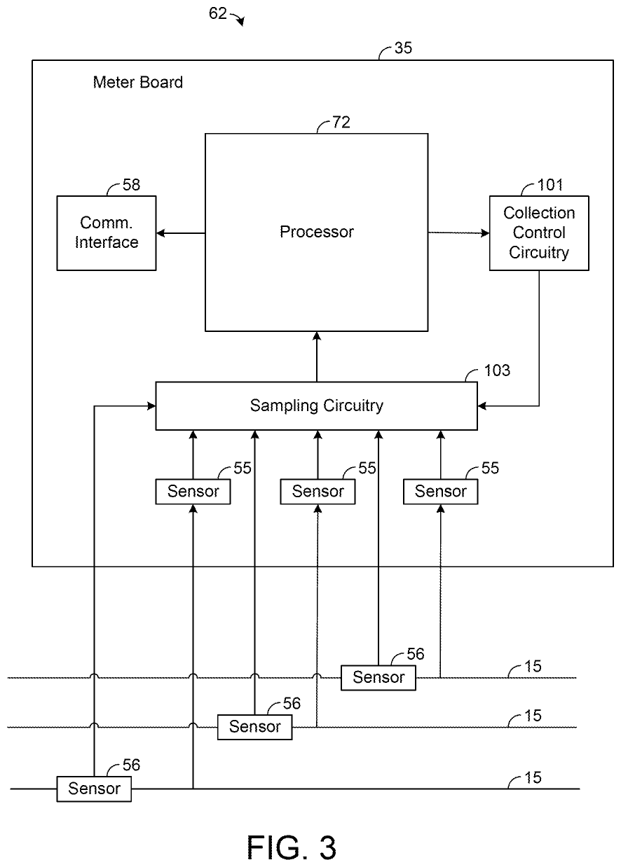

FIG. 3 depicts an embodiment of a power meter 62 in accordance with the present disclosure. As shown by FIG. 3, the power meter 62 comprises a processor 72 that is configured to collect and analyze sensor data from sensors 55, 56, as described above for the conventional processor 52. However, the power meter 62 is configured to collect the sensor data in a manner that is sufficiently fast to prevent timing errors and reduces processing burdens on a processor 72, allowing it to perform other tasks during collection of sensor data from the sensors 55, 56, as will be described in more detail below. In this regard, the power meter 62 has collection control circuitry 101 that operates off of a clock signal from the processor 72 in order to control the sampling circuitry 103 that takes samples of the sensor signals from the sensors 55, 56, as will be described in more detail below. In some embodiments, except as otherwise described herein, the power meter 62 may be configured and operate the same as the conventional power meter 22 described above with reference to FIG. 2.

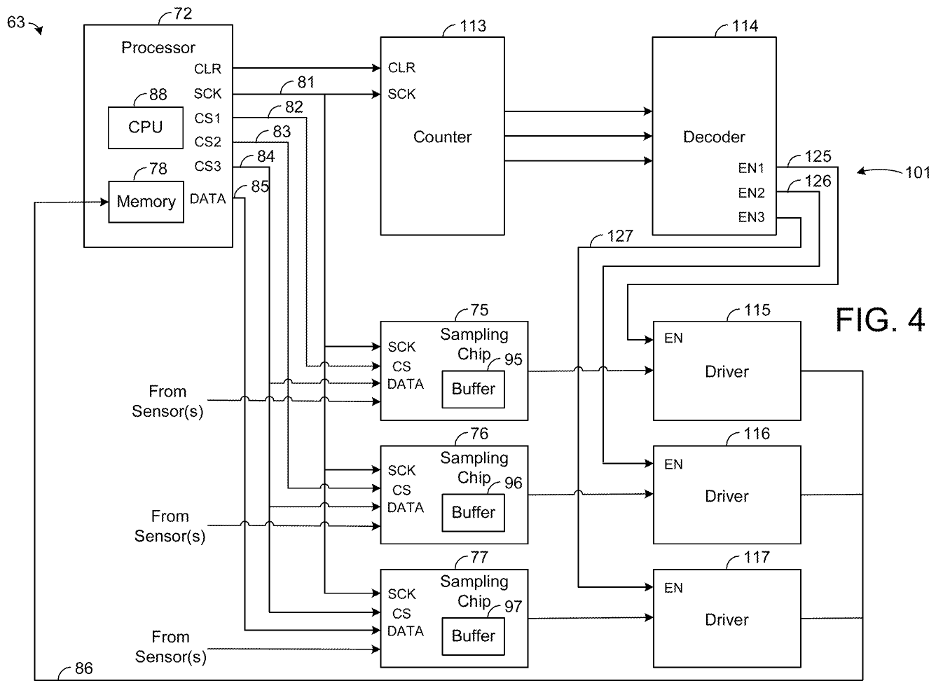

FIG. 4 depicts an embodiment of the collection control circuitry 101 and the sampling circuitry 103. As shown by FIG. 4, the sampling circuitry 103 comprises a plurality of analog-to-digital (A/D) sampling chips 75-77 and a plurality of drivers 115-117 connected between the sampling chips 75-77 and the processor 72. For simplicity of illustration, the sampling circuitry 103 is shown as having three A/D sampling chips 75-77 and drivers 115-117, but there can be any number of sampling chips 75-77 and drivers 115-117 in other embodiments.

Each A/D sampling chip 75-77 is coupled to one or more sensors 55, 56 (FIG. 3) and receives an analog signal from each sensor 55, 56 to which it is coupled. Such sensor signal is an analog signal indicative of the parameter (e.g., voltage or current) sensed by the sensor 55, 56. For a given sample, each sampling chip 75 takes a measurement of the analog signal from the sensor 55, 56 to convert such signal into a digital word (made up of multiple data bytes). As will be described in more detail below, the digital word is sent to the processor 72 and stored in the processor's memory 78 (e.g., one or more registers of the processor 72, although other types of memory may be used). As described above, the processor 72 may analyze the samples of sensor data stored in the memory 78 to determine information about the power signals carried by the power lines 15.

In some embodiments, each A/D sampling chip 75-77 operates in a continuous sampling mode, also sometimes referred to as looping sampling. A continuous sampling analog-to-digital converter may receive signals from more than one sensor and build an internal register table (circular buffer) where conversion results are stored. In this regard, the sensor data captured by each respective sampling chip 75-77 may be stored in a circular buffer 95-97, and the sampling chip continuously outputs the data stored in its buffer 95-97 in response to an active edge of the clock signal received from the processor 72. As used herein, an active edge of a clock signal refers to an edge that triggers a transition of the receiving device to a new state (noting that the active edge of the clock signal can be either a rising edge or falling edge of the clock signal depending on the protocol employed). That is, for every active edge of the clock signal, each A/D sampling chip 75-77 outputs the next bit of sensor data stored in its respective buffer 95-97. Once the end of the circular buffer 95-97 is reached, the A/D sampling chip 75-77 goes back to the beginning of the circular buffer 95-97 to output the next bit. Thus, the A/D sampling chip 75-77 continuously steps through its circular buffer 95-97 transitioning to a new bit to be output upon the occurrence of each active edge of the clock signal from processor 72.

In some embodiments, the processor 72 is implemented via an integrated circuit (IC), also sometimes referred to as a “chip,” separate from the A/D sampling chips 75-77, which are electrically connected to the processor 72 by a plurality of conductive lines 81-86 (e.g., traces). As an example, in one embodiment, the processor 72 is implemented as a conventional microprocessor chip having a central processing unit (CPU) 88 that executes software and performs basic functions of the microprocessor, as known in the art, but other types of processors may be used in other embodiments. In addition, when the processor 72 is collecting sensor data from the A/D sampling chips 75-77, the processor 72 is configured to operate in a direct memory access (DMA) mode that permits data to be written to the memory 78 independently of the CPU 88. That is, after issuing a sampling command instructing the A/D sampling chips 75-77 to take a sample of sensor data, the CPU 88 is not tasked with controlling the writing of such sensor data to the memory 78. Thus, the CPU resources of the processor 72 may efficiently perform other tasks while sensor data from the A/D sampling chips 75-77 is being written to the memory 78, as will be described in more detail hereafter.

The processor 72 is configured to communicate with the A/D sampling chips 75-77, as well as other components of the power meter 62 via the conductive lines 81-86. In this regard, the line 81 carries a clock signal generated by the processor 72, and the lines 82-84 are chip select lines to indicate which A/D sampling circuit 75-77 is currently designated for communicating with the processor 72. The line 85 is a data line for carrying data from the processor 72 to the A/D sampling chips 75-77, and the line 86 is a data line for carrying data from the A/D sampling chips 75-77 to the processor 72. In some embodiments, a data line may carry data in both directions between the processor 72 and the A/D sampling chips 75-77.

When the processor 72 is to transmit information (e.g., a command or control settings) to a given sampling chip 75-77, the processor 72 is configured to activate the chip select signal transmitted to the chip 75-77 via its respective chip select line 82-84 and transmit the information to the chip 75-77 via the data line 85. Note that, if the same information (e.g., command) is to be communicated to multiple chips 75-77, the chip select signal to each such chip 75-77 may be simultaneously activated.

As shown by FIG. 4, the power meter 62 comprises collection control circuitry 101 that is configured to control the collection of sensor data from the sampling chips 75-77. In the embodiment depicted by FIG. 4, the collection control circuitry 101 comprises a counter 113 and decoder 114. In some embodiments, the counter 113 and decoder 114, as well as the drivers 115-117, are each implemented as a separate IC or chip.

In one embodiment, the counter 113 is implemented as an IC or chip forming a high-speed ripple counter with a synchronous clear function, but other types of counters are possible in other embodiments. The counter 113 is configured to count active clock edges of the clock signal on line 81 and output a digital value indicative of this count. The decoder 114 is configured to receive the digital value and output a plurality of enable signals on lines 125-127 that are configured to selectively enable the drivers 115-117. In this regard, at a given time, the decoder 114 is configured to activate only one enable signal, thereby enabling the driver 115-117 that is receiving such activated enable signal. The control of the enable signals by the decoder 114 will be described in more detail below.

When a driver 115-117 is enabled, the driver 115-117 is configured to drive the data line 86 with data from the respective sampling chip 75-77 coupled to it. Thus, the sensor data output by such sampling chip 75-77 is transmitted across the data line 86 to the processor 72 and stored in the memory 78. When disabled, a driver 115-117 electrically disconnects its input from the data line 86 such that the data being output by the sampling chip 75-77 connected to it does not affect the voltage of the data line 86. Thus, the data from the sampling chip 75-77 connected to the disabled driver does not interfere with the data being transmitted across the data line 86 by the enabled driver.

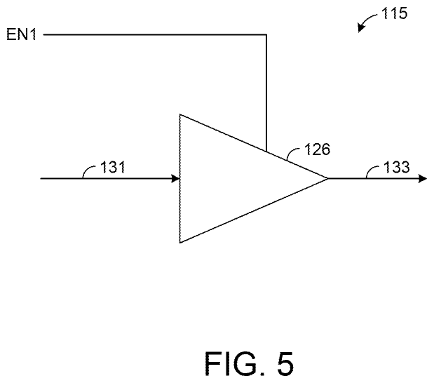

In some embodiments, each driver 115-117 is respectively implemented as an IC or chip comprising a tri-state buffer 126, as shown by FIG. 5, having a high-output state, a low-output state, and a high-impedance state. In this regard, when the tri-state buffer 126 is enabled by an activated enable signal from the decoder 114, the tri-state buffer 126 is forced to either the high-output state or a low-output state depending on the logic level of the binary value output by the sampling chip 75 connected to it. For example, if the logic level of the binary value from the sampling chip 75 is high, the tri-state buffer 126 may be forced to the high-output state where its output is at a high logic value. However, if the logic level of the binary value from the sampling chip 75 is low, the tri-state buffer 126 may be forced to the low-output state where its output is at a low logic value. When the tri-state buffer 126 is disabled by the decoder 114 (e.g., the enable signal from the decoder 114 is not activated), the tri-state buffer 126 is forced into a high impedance state for which the impedance of the tri-state buffer 126 is sufficiently increased such that the input connection 131 of the tri-state buffer 126 coupled to the sampling chip 75 is effectively disconnected electrically from the output connection 133 of the tri-state buffer 126 and thus the data line 86 coupled to such output connection 133. Note that FIG. 5 shows an exemplary circuit for the driver 115, but the other drivers 116, 117 may have the same configuration and operation as described above for driver 115.

When a sample of sensor data is to be taken and stored in the memory 78 of the processor 72, the decoder 114 is configured to enable a first driver 115 while disabling the other drivers 116, 117 such that sensor data output by the A/D sampling chip 75 connected to such enabled driver 115 is serially transmitted from the sampling chip 75 across the data line 86 to the processor 72 and stored in the processor's memory 78. Specifically, for each active edge of the clock signal on line 81, the sampling chip 75 transitions to transmitting a new bit value of the sensor data stored in the sampling chip 75.

Once a sufficient number of active edges are counted by the counter 113 such that all the sensor data to be transmitted by the sampling chip 75 for the sample has in fact been transmitted, the decoder 114 is configured to deactivate the enable signal transmitted to the driver 115, thereby disabling the driver 115, and activate the enable signal transmitted to the next driver 116, thereby enabling the driver 116. Thus, noting that the driver 117 remains disabled, the sampling chips 75, 77 are effectively disabled from communicating across the data line 86, and the sampling chip 76 is effectively enabled to transmit its sensor data across the data line 86.

Once a sufficient number of active edges are counted by the counter 113 such that all the sensor data to be transmitted by the sampling chip 76 for the sample has in fact been transmitted, the decoder 114 is configured to deactivate the enable signal transmitted to the driver 116, thereby disabling the driver 116, and activate the enable signal transmitted to the next driver 117, thereby enabling the driver 117. Thus, noting that the driver 115 remains disabled, the sampling chips 75, 76 are effectively disabled from communicating across the data line 86, and the sampling chip 77 is effectively enabled to transmit its sensor data across the data line 86.

Once a sufficient number of active edges are counted by the counter 113 such that all the sensor data to be transmitted by the sampling chip 77 for the sample has in fact been transmitted, the decoder 114 is configured to deactivate the enable signal transmitted to the driver 117. If there are additional sampling chips (not shown) and additional drivers (not shown) that have yet to communicate sensor data to the processor 72 for the sample, then additional drivers may be similarly enabled, as described above for drivers 115-117, so that additional sampling chips may transmit their sensor data one-at-time to the processor 72. This process may continue until all the sampling chips have been allowed to transmit sensor data to the processor 72, as appropriate.

In some embodiments, the counter 113 and decoder 114 implement a clock frequency divider function where the frequency of the clock signal on line 81 is divided by the number of bits to be transmitted by a single sampling chip 75 for a given sample. In this regard, the decoder 114 transitions to activating a new enable signal after a number of active clock edges have occurred for the previously-enabled sampling chip 75 to transmit its sensor data for the current sample. Thus, once one sampling chip 75 transmits all its sensor data for the sample, the next sampling chip 76 is quickly enabled such that the next bit is transmitted from the next sampling chip 76 upon occurrence of the next active clock edge. Indeed, the response time of the collection control circuit 101 is sufficiently fast such that bits arrive at the processor 72 at the same rate (i.e., at the rate of the clock signal output by the processor 72) expected by the processor 72. As an example, one bit may be received for each active edge of the clock signal.

Thus, data is effectively clocked into the processor 72 at the rate expected by the processor (e.g., the same rate of the processor's clock signal), and the operation of the collection control circuitry 101 is transparent to the processor 72. However, the collection control circuitry 101 effectively manages the selection of the sampling chips 75-77 for transmission to the processor 72 so that the processor 72 does not need to perform tasks related to chip selection or other aspects of controlling data collection, thereby freeing the CPU 88 of the processor 72 to perform other tasks while sensor data is being written to the memory 78. That is, from the processor's perspective, the sensor data received by the processor 72 appears to come from a single data source that does not require management of the chip select function for receiving the data even though the sensor data is actually received from multiple sources (e.g., sampling chips 75-77), thereby enabling the processor 72 to operate in the DMA mode.

To better illustrate the foregoing, assume that each A/D sampling chip 75-77 stores 128 bits of sensor data per sample, and there are three A/D sampling chips 75-77 such that there is a total of 384 bits of sensor data stored to the memory 78 per sample. When a sample is to be taken, the processor 72 issues a sample command instructing each sampling chip 75-77 to take a sample of sensor data. In response, each sampling chip 75-77 simultaneously takes a measurement of each analog signal from its respective sensor(s) 55, 56. In taking such measurement, each sampling chip 75-77 samples each of its analog signals to provide a 128 digital value indicative of the measured analog signals.

As part of the sample command, the processor 72 activates a clear signal that is received by the counter 113, which clears its output (e.g., resets its output to a value of 0) in response to the clear signal. At this time, assume that the decoder 114 is activating the enable signal transmitted to the driver 115 such that the driver 115 is enabled. Thus, for each active edge of the clock signal, the sampling circuit 75 transmits a new bit value of its sensor data to the processor 72, and such bit value is stored in the memory 78. During this time, the drivers 116, 117 are disabled by the decoder 114 such that the sampling chips 76, 77 are electrically disconnected from the data line 86 by the drivers 116, 117, respectively.

After a threshold number (e.g., 128 in the current example) active clock edges have occurred, the sampling chip 75 has transmitted all its sensor data for the sample (e.g., 128 bits) to the processor 72. Thus, on the 129th active clock edge since issuance of the sample command, the decoder 114 transitions state by deactivating the enable signal transmitted to the driver 115, thereby disabling the driver 115, and activating the enable signal transmitted to the driver 116, thereby enabling the driver 116. At this time, the sampling chip 76 is electrically connected to the data line 86 (and the sampling chips 75, 77 are electrically disconnected from the data line 86) such that a bit of the sensor data in the sampling chip 76 is transmitted to the processor 72. The processor 72 continues to clock the sampling chip 76 while the driver 116 is enabled for another 127 active clock edges at which point the sampling chip 76 has transmitted all its sensor data for the sample to the processor 72.

After another threshold number (e.g., 128 in the current example) active clock edges have occurred (e.g., 256 total active clock edges since issuance of the sample command), the sampling chip 76 has transmitted all its sensor data for the sample (e.g., 128 bits) to the processor 72. Thus, on the 257th active clock edge since issuance of the sample command, the decoder 114 transitions state by deactivating the enable signal transmitted to the driver 116, thereby disabling the driver 116, and activating the enable signal transmitted to the driver 117, thereby enabling the driver 117. At this time, the sampling chip 77 is electrically connected to the data line 86 (and the sampling chips 75, 76 are electrically disconnected from the data line 86) such that a bit of the sensor data in the sampling chip 77 is transmitted to the processor 72. The processor 72 continues to clock the sampling chip 77 while the driver 117 is enabled for another 127 active clock edges at which point the sampling chip 77 has transmitted all its sensor data for the sample to the processor 72.

At this time, the decoder 114 again changes state by deactivating the enable signal transmitted to the driver 117. As noted above, if there are additional drivers and sampling chips, then the next driver would be enabled by the decoder 114 so that additional sensor data is transmitted. However, since there are only three sampling chips 75-77 in the current example, the sample operation is complete after 384 active clock edges have occurred such that 384 bits of sensor data from the sampling chips 75-77 have been written to the memory 78.

1. A power meter for monitoring power signals from power lines, comprising:
a plurality of sensors coupled to a plurality of power lines, each of the plurality of sensors configured to sense parameters of power signals carried by the plurality of power lines;
a first sampling chip coupled to the plurality of sensors for receiving at least one first analog signal indicative of at least one power signal carried by the plurality of power lines, the first sampling chip configured to convert the at least one first analog signal into first sensor data;
a second sampling chip coupled to the plurality of sensors for receiving at least one second analog signal indicative of at least one power signal carried by the plurality of power lines, the second sampling chip configured to convert the at least one second analog signal into second sensor data;
a processor coupled to the first sampling chip and the second sampling chip by a clock line, the processor configured to transmit a clock signal across the clock line to the first sampling chip and the second sampling chip;
a counter external to the processor and coupled to the processor by the clock line, the counter configured to receive the clock signal from the clock line and to count transitions of the clock signal, the counter further configured to transmit a count value indicative of a number of transitions of the clock signal counted by the counter;
a first driver coupled to the processor by a data line, the first driver coupled to the first sampling chip and configured to drive the data line with the first sensor data from the first sampling chip when enabled;
a second driver coupled to the processor by the data line, the second driver coupled to the second sampling chip and configured to drive the data line with the second sensor data from the second sampling chip when enabled; and
a decoder external to the processor and coupled to the counter, the first driver, and the second driver, the decoder configured to selectively enable the first driver and the second driver based on the count value.

2. The power meter of claim 1, wherein the decoder is configured to transmit a first enable signal to the first driver and a second enable signal to the second driver, wherein the decoder is configured to activate the first enable signal while deactivating the second enable signal until the count value surpasses a first threshold, wherein the decoder is configured to activate the second enable signal and deactivate the first enable signal when the count value surpasses the first threshold.

3. The power meter of claim 1, wherein the processor is configured to operate in a direct memory access (DMA) mode for receiving and storing into memory of the processor the first sensor data and the second sensor data.

4. The power meter of claim 1, wherein the first driver comprises a tri-state buffer.

5. The power meter of claim 1, wherein each of the first sampling chip and the second sampling chip is configured to operate in a continuous sampling mode.

6. The power meter of claim 1, wherein the counter is a ripple counter.

7. The power meter of claim 6, wherein the ripple counter has a synchronous clear function based on a clear signal received from the processor.

8. A method for monitoring power signals from power lines, comprising:
sensing, with a plurality of sensors coupled to a plurality of power lines, parameters of power signals carried by the plurality of power lines;
receiving, with a first sampling chip from the plurality of sensors, at least one first analog signal indicative of at least one power signal carried by the plurality of power lines;
converting, with the first sampling chip, the at least one first analog signal into first sensor data;
receiving, with a second sampling chip from the plurality of sensors, at least one second analog signal indicative of at least one power signal carried by the plurality of power lines;
converting, with the second sampling chip, the at least one second analog signal into second sensor data;
transmitting a clock signal from a processor;
receiving the clock signal at the first sampling chip;
receiving the clock signal at the second sampling chip;
receiving the clock signal at a counter external to the processor;
counting transitions of the clock signal with the counter;
transmitting, with the counter, a count value indicative of a number of transitions of the clock signal counted by the counter;
driving, with a first driver when the first driver is enabled, a data line with the first sensor data from the first sampling chip, wherein the data line is coupled to the processor;
driving, with a second driver when the second driver is enabled, the data line with the second sensor data from the second sampling chip;
receiving the count value with a decoder external to the processor; and
selectively enabling, with the decoder, the first driver and the second driver based on the count value.

9. The method of claim 8, further comprising:
transmitting, with the decoder, a first enable signal to the first driver;
transmitting, with the decoder, a second enable signal to the second driver;
activating, with the decoder, the first enable signal while deactivating the second enable signal until the count value surpasses a first threshold; and
activating, with the decoder, the second enable signal and deactivating the first enable signal when the count value surpasses the first threshold.

10. The method of claim 8, further comprising operating the processor in a direct memory access (DMA) mode for receiving and storing into memory of the processor the first sensor data and the second sensor data.

11. The method of claim 8, wherein the first driver comprises a tri-state buffer.

12. The method of claim 8, further comprising:
operating the first sampling chip in a continuous sampling mode; and
operating the second sampling chip in a continuous sampling mode.

13. The method of claim 8, wherein the counter is a ripple counter.

14. The method of claim 13, further comprising clearing the counter in response to a clear signal from the processor.
